(19) United States
(12) Patent Application Publication
(10) Pub. No.: US 2012/0310705 A1
(43) Pub. Date: Dec. 6, 2012

(54) METHOD AND SYSTEM FOR SEPARATING DEMAND MODELS AND DEMAND FORECASTS INTO CAUSAL COMPONENTS

(76) Inventors: Brent Joseph May, Scottsdale, AZ (US); Gustavo Ayres de Castro, Scottsdale, AZ (US); Yetkin Ileri, Scottsdale, AZ (US); Mohamed Mneimneh, Scottsdale, AZ (US); Kautilya Patel, Tempe, AZ (US); Geoffrey Hutton, Scottsdale, AZ (US)

(21) Appl. No.: 13/153,973

(22) Filed: Jun. 6, 2011

(51) Int. Cl. G06Q 10/00

(52) U.S. Cl. 705/7.31

(57) ABSTRACT

According to some embodiments, a method and system provides separating demand models and forecasts into demand components thereof. The methods include receiving a demand model to forecast a demand for a product or service; decomposing the demand model into a plurality of distinct demand components, each of the demand components associated with a causal contribution to a demand for the product or service; and generating a demand forecast including an indication of the plurality of demand components associated with the causal contributions contributing to the demand forecast for the product or service. Some embodiments include a method to determine demand components of a demand model for a product or service based on historical data.

### FIELD

The present invention relates, in general, to demand modeling and demand forecasting and, more particularly, to a system and method of separating demand models and demand forecasts into relevant components.

### BACKGROUND

Systems and methods for demand modeling and demand forecasting are oftentimes used to estimate or predict a performance outcome of a commerce or economic system, given specific sets of relevant input data. Demand forecasts may benefit a business entity by providing a new and actionable information for a product or service in terms of expected or predicted units sold or revenue generated. The business entity, such as a business manager, marketer, retailer, manufacturer, distributor, and other business service providers may use the forecasted demand for the product or service in making business decisions related to the particular product or service. For example, a manufacturer may decide whether to increase (decrease) manufacturing output for a future shopping season based on a forecast of rising (lowering) demand for the manufacturer's products in that future shopping period.

In many instances demand forecasts commonly provide an indication or reporting of a total demand for a product or service, in terms of predicted or estimated units sold and/or revenue generated based on sales. This type of overall, total demand forecast may provide some guidance to a business entity or business decision-maker as stated above. However, the total or overall demand forecast may be too broad or too “coarse” to provide a business manager or decision-maker the information with the information necessary for them to make strategic business decisions based on the demand forecast. For instance, the total demand forecast may not be sufficient to inform a business manager the key information they need to determine which aspects of a marketing campaign, if any, should be adjusted in order to effectively enhance future sales of a product during an upcoming fiscal quarter.

In some instances, the total demand forecast may not reveal and/or may even tend to obscure business relevant data that a business entity may desire or need in order to make informed business decisions. For example, an overall demand forecast may suggest an increased future (i.e., forecast) demand for a product. Based on such a forecast, the business entity (e.g., a retailer) may be persuaded to decide to maintain the same types and levels of product promotions, in order to achieve the forecasted demand increase. However, if the business entity had greater insight into the drivers of the demand forecast the business entity may be informed to accept, change, or reject the forecast or any component of the forecast and thus have additional control over the business entity.

### BRIEF DESCRIPTION OF THE DRAWINGS

FIG. 1 is a block diagram of a system according to some embodiments.

FIG. 2 is a flow diagram for decomposing a demand model according to some embodiments.

FIG. 3 is a flow diagram of a process for decomposing a linear demand model according to some embodiments.

FIG. 4 is a flow diagram of a process for decomposing a multiplicative demand model according to some embodiments.

FIG. 5 is another flow diagram of a process for decomposing a multiplicative demand model according to some embodiments.

FIG. 6 is a flow diagram of a process for determining and demand model according to some embodiments.

FIG. 7 is a block diagram of a system according to some embodiments.

FIG. 8 is a block diagram of a system according to some embodiments.

### DETAILED DESCRIPTION

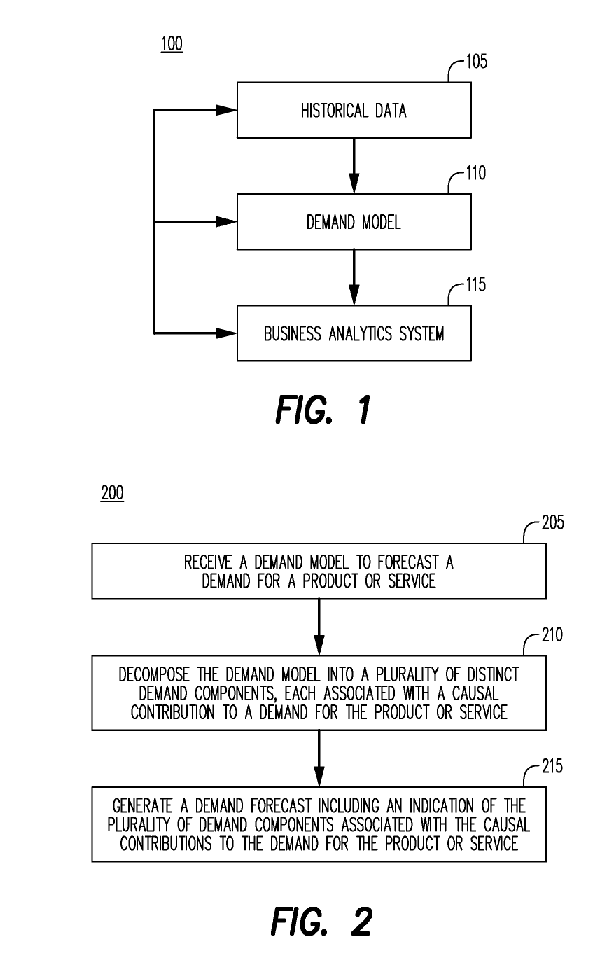

A method, system, and mechanism for efficiently separating a demand model and a demand forecast into causal components thereof are provided by some embodiments herein. As introduced above, a business entity may desire greater insight into the drivers of a demand forecast than that provided by a demand model that provides a total or overall demand metric or measure. Accordingly, the demand models and forecasts provided in some embodiments herein (e.g., demand model 110 of FIG. 1) may provide an indication of the constituent causal components of a demand forecast that drive or otherwise contribute to the forecast generated by the demand model.

FIG. 1 provides aspects of a commerce system 100, in accordance with some embodiments of demand models and demand forecasts herein. As shown, historical data, including in some instances transactional sales data, related to the product is provided at operation 105. The historical data 105 may be received, retrieved, determined, or otherwise obtained by a person, system, or other entity by any method and means now known or that becomes known in the future. In some instances, historical data 105 is provided by one or more entities also associated with commerce system 100 and in some other instances the historical data may be provided by a business service provider that functions to provide the historical data and is not otherwise associated with commerce system 100. In some embodiments, historical data 105 may include one or more of sales data received from retailers, invoiced orders received from distributors, purchase orders received from manufacturers, and other sources.

Based on historical data 105, a demand model may be generated at operation 110. Demand model 110 may be represented as a mathematical expression that provides a predicted or anticipated outcome, based on a given set of input data and assumptions. The input data may be processed through the mathematical expression representing either an expected or current behavior of commerce system 100. The mathematical expression may be derived from and based on principles of probability and statistics, including analyzing historical data 105 and corresponding known outcomes related thereto, to achieve a “best fit” of the expected behavior of the system to other sets of data. In this manner, demand model 110 may predict or forecast a demand for products in commerce system 100. Demand model 110 may generate a forecast sales demand based on a number of considerations, as will be explained in greater detail below, such as a proposed price, type of associated promotion, seasonal, holiday, and other attributes of the subject product.

Business analytics system 115 may include one or more of a manufacturer, distributor, retailer, or other entity of commerce system 100, such as a business service provider or system, that may use demand model 110 to control business decisions and business operations related to commerce system 100. In some embodiments, decisions and actions related to the manufacturing, distribution, and sale of the products associated with commerce system 100 may be made based on a demand forecast provided by demand model 110. In some embodiments, business analytics system 115 may be provided by or on the behalf of the one or more manufacturers, distributors, retailers, or other entities associated with commerce system 100, by means of local, remote, or distributed computer systems (not shown).

In some aspects, business analytics system 115 may further provide historical (transactional) data 105 that is then passed to demand model 110. The data provided to demand model 115 from the business analytics system 110 may be used to dynamically generate updated forecasts predicting the demand for the products of commerce system 100. In some aspects, the entities (e.g., persons and systems) of business analytics system 115 may make adjustments and/or provide inputs to demand model 110 where the inputs operate to adjust the forecasts provided by the demand model. In some embodiments, the demand model(s) 110, may be generated or otherwise tailored for the particular entities of business analytics system 115 that may use them. As such, historical data 105 used by a demand model 110 may be configured to correspond the pertinent aspects of the business analytics system 115.

The communication of forecasts and other data and information between the various aspects of commerce system 100 may be facilitated by electronic communication links, whether the communication links are permanent, ad-hoc, wired, wireless, and a combination thereof.

Some embodiments herein are associated with systems and methods for providing a demand forecast that includes an indication of the separate components that relate to the causal contributors to the forecasted demand. FIG. 2 is an example of a flow diagram of a process 200 in accordance with some embodiments herein. At operation 205, a demand model to forecast a demand for a subject product or service is received. As used herein, a product or service may be any products, goods, or services that may be represented as distinct quantifiable “units” for determining a demand for those products, goods, and services. In some embodiments, the units of a demand forecast refer to a quantity of units of the products, goods, of services sold in a particular time period. The demand model may be received in a format appropriate for the entity receiving the demand model to use the demand model. Accordingly, the demand model may be formatted in a manner compatible with the recipient of the demand model, whether that recipient is a person, computer, or system, including one or more specific languages, computer programming codes or languages, or computer readable file and data structures. In some embodiments, the received demand model is provided as a mathematical expression (as will be discussed in greater detail below).

At operation 210, the demand model of operation 205 is decomposed or otherwise separated into a plurality of distinct demand components that contribute to the overall or total demand for the subject product or service. The plurality of distinct demand components may each be associated with a causal contribution to the total demand for the subject product or service. Decomposing the demand model and/or the demand forecast into its associated demand components may involve one or more mathematical processing operations since the received demand model may be a mathematical expression.

In some embodiments herein, the causal demand components may include, for example, demand components due to Seasonality pertaining to a season of a year, a Holiday, an identifiable Trend, Daily adjustments within a week, Daily/Weekly adjustments within a month, Price drivers, Promotion (and promotion sub-components), Availability of the product, a Redemption Rate for the product or service, Cannibalization due to other products and services, an Affinity consumers of the product or service may have or exhibited towards the product or service, and Pantry Loading.

It should be appreciated that the particular demand components disclosed herein are not intended to be an exclusive or exhaustive listing of the demand components contemplated and within the scope of the present disclosure. Other, alternative, substitute, fewer, and more demand components should be understood to be within the scope of the present disclosure, including obvious and non-obvious modifications of the example demand components explicitly disclosed herein.

Process 200 continues to operation 215 where a demand forecast is generated. The generated forecast demand includes a plurality of demand components from operation 210 associated with the causal contributions to the demand for the subject product or service. In some embodiments, the generated demand forecast may be provided in a report or presentation, including texts and/or graphical representations of relative values of the demand components comprising the demand forecast. In some embodiments, the generated demand forecast may be presented in a manner, format, and structure that are understood by a person, computer, or system, appropriate to the uses and implementations of the methods and systems disclosed herein.

Regarding the demand model, it is noted that the demand model herein may generally be expressed mathematically as separable multiplicative effects or additive (i.e., linear) effects. As used herein, a linear demand model includes additive components. As referred to herein, a nonlinear demand model may include multiplicative components. Where the demand model is a pure multiplicative model, the term “multiplicative” will be used. As such, the modeled demand may be expressed as:

$$\begin{matrix}{US}_{demand} = {US}_{0} \cdot \prod {f}_{i} ( multiplicative ) \\ = {US}_{0} + \sum {u}_{i} ( additive )\end{matrix}$$

where US_{demand} represents demand modeled units sold, US₀ is the “baseline” or “base” demand of units sold, fᵢ are the multiplicative “demand factors” that increase or decrease the demand relative to the base demand, and uᵢ are additive (linear) “demand terms”. As used herein, the “base” demand US₀ is the portion of the total demand that exists absent any of the separable contributing demand components.

In embodiments herein, the multiplicative demand factors and the additive demand terms have a one-to-one logical correspondence such that fᵢ [symbol] uᵢ, but their values and application are generally not compatible. That is, in general, fᵢ≠uᵢ. In some embodiments, it may be preferred to express a demand model and its demand components as additive terms since such additive terms may be more readily and easily understood by some business decision-makers (e.g., a business manager).

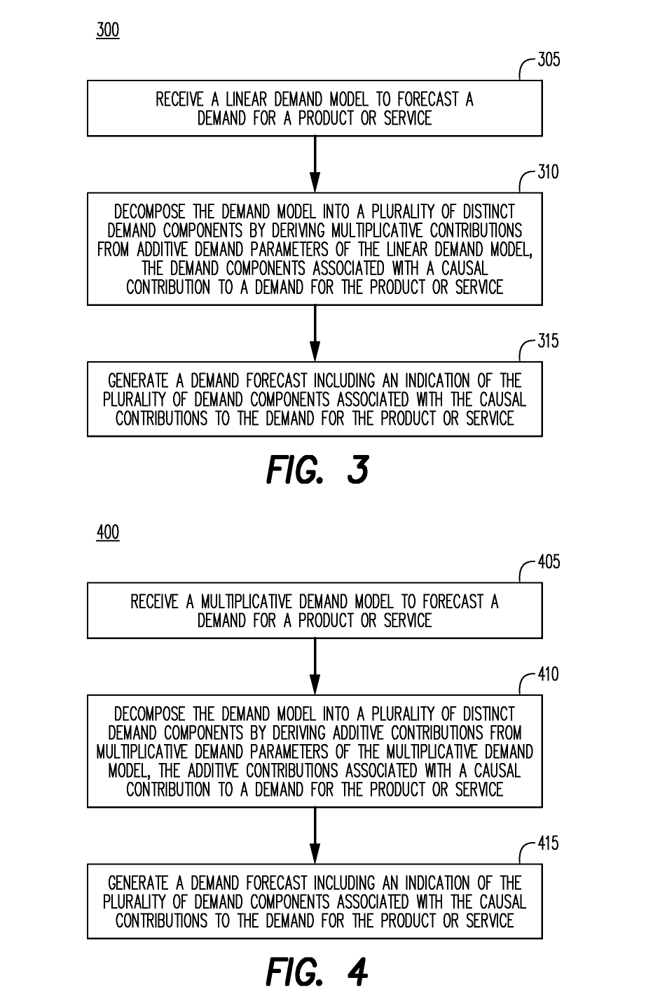

In some embodiments, as illustrated by the flow diagram of FIG. 3 related to a process 300, a linear demand model to forecast a demand for a subject product or service is received at an operation 305. Being a linear demand model, the demand model may be expressed mathematically as a base demand US₀ and a plurality of additive demand components uᵢ, as stated above.

At operation 310, the linear demand model of operation 305 is decomposed or otherwise separated into a plurality of distinct multiplicative demand components that contribute to the overall or total demand for the subject product or service. The multiplicative demand factors are mathematically derived from the linear demand model comprising additive components. Each of the plurality of distinct multiplicative demand components may be associated with a causal contribution to the demand for the subject product or service. Decomposing the linear demand model into associated multiplicative demand components may involve one or more mathematical processing operations.

At operation 315, the demand forecast is generated that includes an indication of the plurality of multiplicative demand components derived at operation 310 corresponding to the causal contributions to the demand for the subject product or service. An output of the generated demand forecast of operation 315 may be provided in a report, file, or presentation provided to or for a person, computer, or system.

In accordance with the present disclosure, any method of converting demand factors fᵢ to additive demand unit sales lifts uᵢ should satisfy the following properties:

fᵢ=1 [symbol] uᵢ=0 (p.1)

0≦fᵢ<1 [symbol] uᵢ21 0 (p.2)

fᵢ>1 [symbol] uᵢ>0 (p.3)

Additional possible properties are:

fᵢ=fᵢ [symbol] uᵢ=uⱼ (p.4)

fᵢ<fᵢ [symbol] uᵢ<uⱼ (p.5)

fᵢ>fⱼ [symbol] uᵢ>uᵢ (p.6)

The properties (p.1)-(p.6) may thus be assumptions considered by the inputs to a demand model herein, in some embodiments. Further, in some embodiments the properties (p.1)-(p.3) may be obeyed whereas the properties (p.4)-(p.6) may be obeyed in some but not all circumstances, depending on other considerations.

FIG. 4 is an illustrative flow diagram of a process 400. Process 400 depicts an embodiment of a method and process to generate a demand forecast that includes additive demand terms derived from a multiplicative demand model comprising multiplicative demand factors. At operation 405, a multiplicative demand model to forecast a demand for a subject product or service is received. Since the demand model is multiplicative, the demand model may be expressed mathematically as a base demand US₀ and a plurality of multiplicative demand components fᵢ, as stated above.

In some instances, it may be desirable to express a demand model and/or demand forecast in additive or linear terms since some persons may consider and understand additive terms more easily than multiplicative factors. At operation 410, the multiplicative demand model of operation 405 is decomposed or otherwise separated into a plurality of distinct additive demand components that contribute to the overall or total demand for the subject product or service. The additive demand terms are mathematically derived from the multiplicative demand model comprising multiplicative components and may each be associated with a causal contribution to the demand for the subject product or service. Decomposing the multiplicative demand model into associated additive demand components may involve one or more mathematical processing operations (as will be discussed in greater detail below).

Referring to operation 415, a demand forecast is generated that includes an indication of the plurality of additive demand components from operation 410. An output of the generated demand forecast of operation 415 may be provided, in some embodiments, in a report, file, or presentation provided to or for a person, computer, or system.

Regarding operation 410, decomposing the multiplicative demand model into associated additive demand components may involve one or more mathematical processing operations. In some embodiments, a process may be used to convert the demand model from multiplicative demand factors to additive demand terms by accounting for each of the various contributory causal effects in a specific sequence. In some embodiments, additive contributions uᵢ are determined from the demand factors fᵢ in a sequence i=1→n using the following equation:

$${u}_{i} = {US}_{0} \cdot ( {f}_{i} - 1 ) \cdot {\prod }_{j = 1}^{i - 1} {f}_{j} \qquad ( d .1 )$$

Solving this equation for a first few example demand factors, it is noted that:

$${u}_{1} = {US}_{0} \cdot ( {f}_{1} - 1 )$$

$${u}_{2} = {US}_{0} \cdot {f}_{1} \cdot ( {f}_{2} - 1 )$$

$${u}_{3} = {US}_{0} \cdot {f}_{1} \cdot {f}_{2} \cdot ( {f}_{3} - 1 )$$

$$⋮$$

It may be mathematically determined and confirmed that:

$${\sum }_{i = 1}^{n} {u}_{i} = {US}_{0} \cdot {\prod }_{i = 1}^{n} {f}_{i} - {US}_{0} , \\ thus$$

$${US}_{0} + {\sum }_{i = 1}^{n} {u}_{i} = {US}_{0} \cdot {\prod }_{i = 1}^{n} {f}_{i} .$$

Referring back to the assumed properties introduced above, it is noted that this process of deriving the additive terms from the multiplicative factors in a specific sequenced manner does not necessarily satisfy the properties (p.4)-(p.6). Yet, this process may be useful for some business users based on which demand factors are more important and/or should be applied (i.e., considered) before other demand factors. As an example, the effect of a price change on a promotion may be calculated according to a sequenced method herein before applying a promotional effect. Therefore, a business manager may observe the same “price contribution” to a demand notwithstanding whether the price changed with or without a promotion.

In some aspects herein, other or alternative mathematical processes may be used to convert or decompose a multiplicative demand model into a plurality of distinct additive demand components. In some embodiments, it may be assumed that the multiplicative demand factors all affect each other and, accordingly, act “concurrently” to influence the demand. In this context of concurrently decomposing the demand model into a plurality of additive demand components, the calculation of the additive contributions uᵢ may rely on an optimized mix of combinations of the demand factors expressed as follows:

uᵢ=US₀·(fᵢ−1)·wᵢⁿ(f₁, f₂, . . . , fₙ) (d.2)

where US₀ is the “baseline” demand, n is the number of demand factors f, and

$$\begin{matrix}{w}_{i}^{n} ( {f}_{1} , {f}_{2} , … , {f}_{n} ) = \frac{1}{\text{?} l} ( ( \text{?} - 1 ) \vert + {\sum }_{k = 1}^{n - 1} {\sum }_{\text{?}}^{ } k \vert ( \text{?} - 1 - k ) \vert f {\text{?}}_{1} f {\text{?}}_{2} … f {\text{?}}_{t} ) & ( d .3 ) \\ \text{?} \text{indicates text missing or illegible when filed} & \end{matrix}$$

It is noted that the factor wᵢⁿ(f₁, f₂, . . . , fₙ) accounts for all possible sequences to calculate the additive terms. Moreover, this conversion approach satisfies properties (p.4)-(p.6).

Referring again to FIG. 4, operation 410 may be implemented by a sequenced conversion or a concurrent conversion of multiplicative demand factors to additive demand factors by mathematical processes, as disclosed above. In some other embodiments, a combination or hybrid conversion process including both a sequenced conversion and a concurrent conversion of multiplicative demand factors to additive demand factors may be provided. In some embodiments, the particular type of conversion process used (e.g., sequenced, concurrent, or combination) may depend, at least in part, on one or more business decisions.

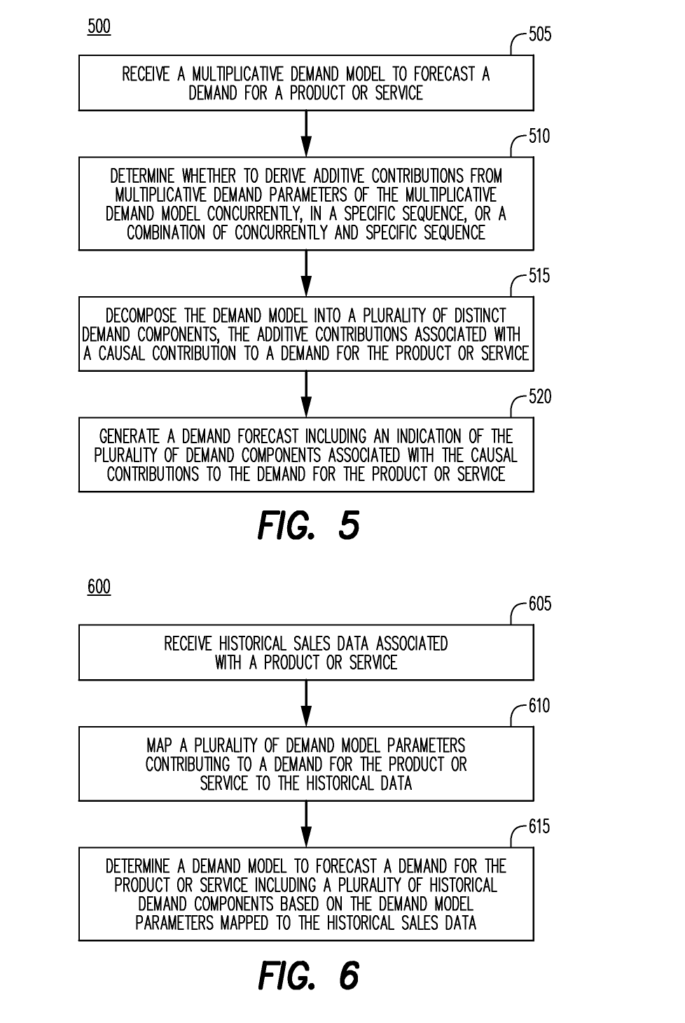

FIG. 5 illustrates a flow diagram of a process 500 for a method and process to generate a demand forecast that includes additive demand terms from a multiplicative demand model comprising multiplicative demand factors. Process 500 is similar in some aspects to process 400. In particular, operation 505 is similar to operation 405 and operation 520 is similar to operation 415. Accordingly, a detailed discussion of operations 505 and 520 is not provided herein since an understanding of these operations may be readily understood by referring to the discussion of operations 405 and 415.

Operation 510 of process 500 provides a mechanism to determine whether additive contributions are derived from multiplicative demand parameters of the multiplicative demand model of operation 505 according to a sequenced, concurrent, or hybrid (i.e., combination of concurrently and sequenced) conversion process. Operation 515 decomposes the multiplicative demand model according to the determination of operation 510. Thereafter, a demand forecast may be generated at operation 520.

Some embodiments herein provide a method and system to determine a demand model for a product or service. FIG. 6 is an example of a flow diagram of a process 600. At operation 605, historical data related to or otherwise associated with a product or service is received. In some instances, the historical data includes empirical sales data based on real world sales from known periods of time. At operation 610, a process or mechanism is provided to map or otherwise correlate a plurality of demand model parameters to the historical data. In particular, the demand model provides a modeled demand for the product or service and the demand model parameters may each represent causal contributors to the demand for the product or service.

In some embodiments, although not explicitly shown in FIG. 6, the demand model of process 600 may be received or otherwise obtained prior to operation 610. In some embodiments, the received demand model may be decomposed into the plurality of demand model parameters. In other embodiments, process 600 may further include an operation (not shown) for decomposing the demand model into the plurality of distinct demand model parameters.

At operation 615, a demand model to forecast a demand for the product or service may be determined. The determined demand model may include a plurality of historical demand components based on the demand model parameters mapped to the historical data in operation 610. The demand model may be determined by adjusting at least one of the mapped plurality of demand parameters to account for a difference between an actual demand for the product or service based on the historical sales data and the modeled demand. In some embodiments, the demand model of operation 615 may be represented as a mathematical expression. In some embodiments, the demand model may include a base demand as well as causal contributing demand components.

In some embodiments, a modeled demand forecast for the demand model includes a base demand component and at least one demand component to account for a difference between an actual demand based on the historical sales data and the modeled demand. In some aspects, the modeled demand (unit sales) may be expressed as:

US_{demand}^{model}=Σvᵢ^{model}+Σuᵢ^{model}

where vᵢ^{model} are additive modeled demand terms assumed to be constant comprising the base demand component, and uᵢ^{model} are terms to be rescaled to account for a difference between the actual demand as determined based on the historical sales data and the modeled demand.

In some aspects, historical demand components uᵢ^{actual} may be determined based on modeled demand expressed as:

$${u}_{i}^{actual} = {u}_{i}^{model} \cdot \frac{{US}_{demand}^{actual} - \sum {v}_{i}^{model}}{\sum {u}_{i}^{model}}$$

where the term US_{demand}^{actual} is known actual demand.

In some embodiments, at least one of the mapped plurality of demand components may be adjusted to account for a difference between the actual demand for the product or service based on the historical sales data and the modeled demand and remaining others of the plurality of demand components are not adjusted. In some aspects, the plurality of demand components includes a base demand component that is not adjusted.

Following below are a number of examples for a demand model including a base demand and a plurality of demand components. While the following examples may include a simplified demand model and a limited number of demand components for purposes of clarity, the examples do not limit the scope of the methods and systems herein.

In the following illustrative examples it is assumed that a simplified demand model includes a base demand of US₀=100 and the following multiplicative demand factors of:

Seasonality demand factor: fₛₑₐₛ=0.8

Price demand factor: f_{price}=1.5

Promotion demand factor: fₚᵣₒₘₒ=2

Based on these demand factors, the forecast is provided by:

US=US₀·fₛₑₐₛ·f_{price}·fₚᵣₒₘₒ=240.

Therefore, a net effect of the three demand factors due to seasonality, price, and promotions is 140 units more than the base demand of 100 units. It should be further understood that the while the foregoing example uses specific values, the demand forecast may be extended to consider other values and additional demand factors.

Considering an example of a sequenced conversion of a multiplicative demand model to additive demand components of using equation (d.1) and assuming a sequence of the previously introduced demand factors of seasonality, price and promotion, the three additive demand terms can be calculated from the given multiplicative demand factors as follows in a first, specific sequence:

uₛₑₐₛ=US₀·(fₛₑₐₛ−1)=100·(0.8−1)=−20

u_{price}=US₀·fₛₑₐₛ·(f_{price}−1)=100·0.8·(1.5−1)=40

uₚᵣₒₘₒ=US₀·f ₛₑₐₛ·f_{price}·(f ₚᵣₒₘₒ−1)=100·0.8·1.5·(2−1)=120

Alternatively, using a second (e.g., reverse) sequence, the demand terms may be calculated as follows:

uₚᵣₒₘₒ=US₀·(fₚᵣₒₘₒ−1)=100·(2−1)=100

u_{price}=US₀·fₚᵣₒₘₒ·(f_{price}−1)=100·2·(1.5−1)=100

uₛₑₐₛ=US₀·fₚᵣₒₘₒ·f_{price}·(fₛₑₐₛ−1)=100·2·1.5·(0.8−1)=−60

As illustrated by the two foregoing sequenced determinations, the decomposition values for the demand factors contributing to a demand forecast depends on the sequence of the calculations.

Considering a concurrent conversion of a multiplicative demand model to additive demand components using equations (d.2) and (d.3), for n=3 (i.e., three demand factors), a “concurrent” conversion of the demand factors results in the following general formula for the additive demand components:

$${u}_{i} = {US}_{0} \cdot ( {f}_{i} - 1 ) \cdot \frac{1}{6} ⌊ 2 ( 1 + {f}_{j} {f}_{k} ) + {f}_{j} + {f}_{k} ⌋$$

Substituting the values of the three demand factors yields:

$${u}_{seas} = {US}_{0} \cdot ( {f}_{seas} - 1 ) \cdot \frac{1}{6} ⌊ 2 ( 1 + {f}_{price} {f}_{promo} ) + {f}_{price} + {f}_{promo} ⌋ = 100 \cdot ( 0.8 - 1 ) \cdot \frac{1}{6} [ 2 ( 1 + 1.5 \cdot 2 ) + 1.5 + 2 ] = - 38.33$$

$${u}_{price} = {US}_{0} \cdot ( {f}_{price} - 1 ) \cdot \frac{1}{6} [ 2 ( 1 + {f}_{seas} {f}_{promo} ) + {f}_{seas} + {f}_{promo} ] = 100 \cdot ( 1.5 - 1 ) \cdot \frac{1}{6} [ 2 ( 1 + 0.8 \cdot 2 ) + 0.8 + 2 ] = 66.66 \\ {u}_{promo} = {US}_{0} \cdot ( {f}_{promo} - 1 ) \cdot \frac{1}{6} [ 2 ( 1 + {f}_{seas} {f}_{price} ) + {f}_{seas} + {f}_{price} ] = 100 \cdot ( 2 - 1 ) \cdot \frac{1}{6} [ 2 ( 1 + 0.8 \cdot 1.5 ) + 0.8 + 1.5 ] = 111.67$$

As seen from the results of the concurrent conversion, the decomposition total (again) equals the expected value of 140 units to be added to the base demand (100 units).

In some embodiments, a combined (i.e., hybrid) method may be used that includes both sequenced and concurrent conversion aspects. Since both the sequenced method and the concurrent methods yield the correct total as illustrated by the examples above, the sequenced and concurrent conversion methods may be arbitrarily combined depending on a need. In one example, it may be prudent or beneficial for a business entity to apply the seasonality demand factor first (in sequence) to the baseline demand since seasonality may be viewed as directly affecting the “base number of shoppers” while the price and promotion demand factors may (concurrently) affect the amount purchased once the shoppers are in the store.

Accordingly, the seasonality is applied in the sequenced method:

uₛₑₐₛ=US₀·(fₛₑₐₛ−1)=100·(0.8−1)=−20

Leading to the total “new baseline” of:

USₛₑₐₛ=US₀+uₛₑₐₛ=100−20=80

This “new baseline” may be used with the price and promotion effects that are determined using the concurrent method via the equation derived from (d.2) and (d.3):

uᵢ=USₛₑₐₛ·(fᵢ−1)·½└1+fᵢ┘

as

$${u}_{price} = {US}_{seas} \cdot ( {f}_{price} - 1 ) \cdot \frac{1}{2} ⌊ 1 + {f}_{j} ⌋ = 80 \cdot ( 1.5 - 1 ) \cdot \frac{1}{2} [ 1 + 2 ] = 60$$

$${u}_{promo} = {US}_{seas} \cdot ( {f}_{promo} - 1 ) \cdot \frac{1}{2} [ 1 + {f}_{j} ] = 80 \cdot ( 2 - 1 ) \cdot \frac{1}{2} [ 1 + 1.5 ] = 100$$

Here too, the decomposition total equals the expected value of 140 units to be added to the base demand (100 units).

In accordance with aspects herein, some of the disclosed methods may be implemented using any number of programming languages and/or techniques, such as Web Dynpro, Java, the Advanced Business Application Programming (ABAP) language, and other languages. In some embodiments, the initial set of historical data may relate to an enterprise that might store and access business information in a number of different ways. For example, an enterprise might store a substantial amount of information about production, sales, marketing, etc. in one or more database structures created by a business service provider (e.g., SAP AG). The initial set of historical data may be provided to a user in a user interface as the result of the user's request for data related to a particular business function and/or organization. The request may comprise a query of a collection of data.

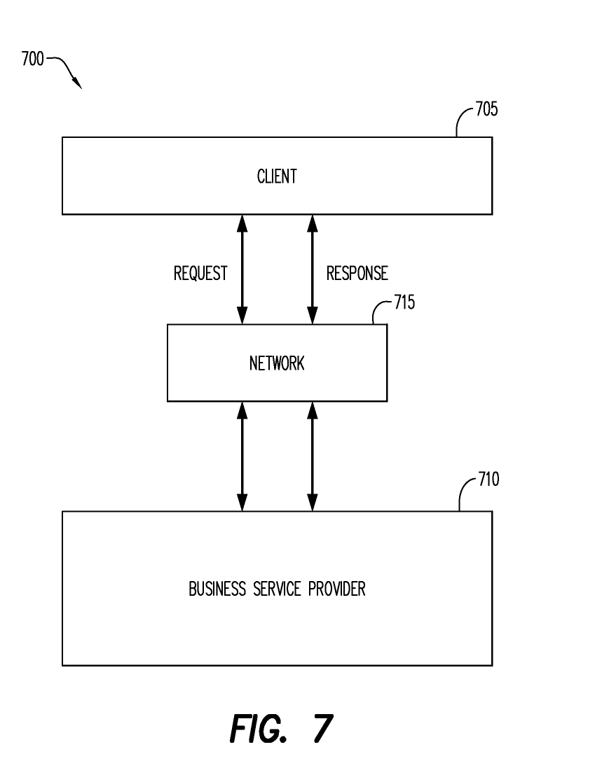

FIG. 7 is a block diagram of a system 700 according to some embodiments. In this case, a business service provider 710 might host and provide business services for a client 705. For example, business service provider 710 may receive requests from the client 705 and provide responses to the client 705 via a service-oriented architecture via a network 715. Note that the business service provider 710 might represent any backend system, including backend systems that belong to the client 705, those that belong to (or are administered by) service providers, those that are web services, etc.

Client 705 may be associated with a Web browser to access services provided by business process platform via HyperText Transport Protocol (HTTP) communication. Client 705, in response, may transmit a corresponding HTTP service request to the business service provider 710 as illustrated. A service-oriented architecture may conduct any processing required by the request (e.g., generating queries related to a demand forecast and executing the queries against a collection of sales data) and, after completing the processing, provides a response (e.g., search results) to client 705. Client 705 may comprise a Personal Computer (PC) or mobile device executing a Web client. Examples of a Web client include, but are not limited to, a Web browser, an execution engine (e.g., JAVA, Flash, Silverlight) to execute associated code in a Web browser, and/or a dedicated standalone application.

In some aspects, FIG. 7 represents a logical architecture for describing processes according to some embodiments, and actual implementations may include more or different elements arranged in other manners. Moreover, each system described herein may be implemented by any number of devices in communication via any number of other public and/or private networks. Two or more of the devices herein may be co-located, may be a single device, or may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

All systems and processes discussed herein may be embodied in program code stored on one or more computer-readable media. Such media may include, for example, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Accordingly, a method and mechanism for efficiently and automatically creating and executing a query based on a selection of data items selected via a user interface are provided by some embodiments herein.

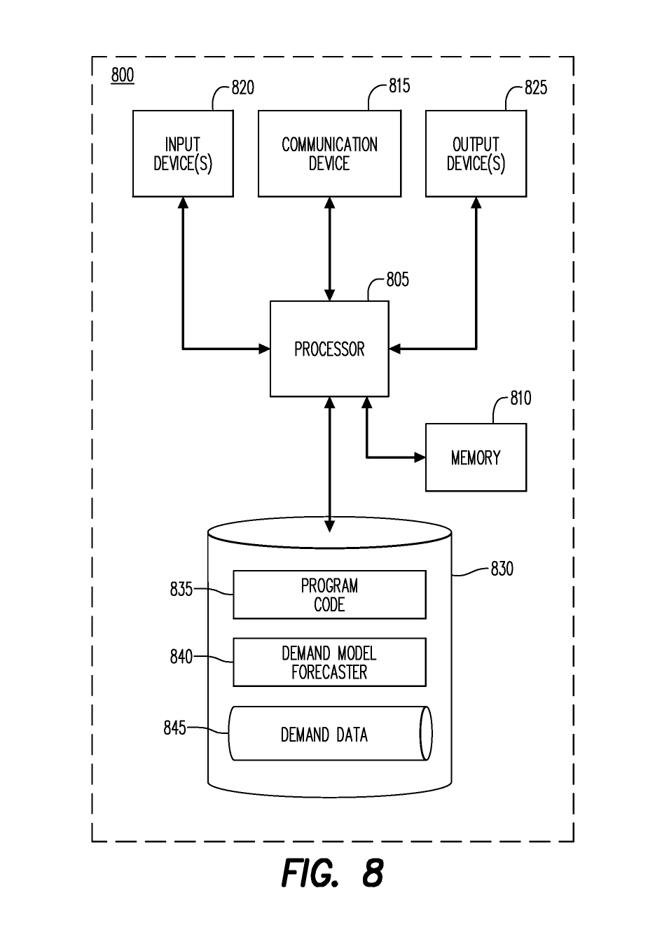

FIG. 8 is a block diagram overview of a system or apparatus 800 according to some embodiments. The system 800 may be, for example, associated with any of the devices described herein, including for example business analytics system 115, client 705, and business service provider 710. The system 800 comprises a processor 805, such as one or more commercially available Central Processing Units (CPUs) in form of one-chip microprocessors or a multi-core processor, coupled to a communication device 815 configured to communicate via a communication network (not shown in FIG. 8) to a front end client (not shown in FIG. 8). Device 800 may also include a local memory 810, such as RAM memory modules. Communication device 815 may be used to communicate, for example, with one or more client devices or business service providers. The system 800 further includes an input device 820 (e.g., a touchscreen, mouse and/or keyboard to enter content) and an output device 825 (e.g., a computer monitor to display a user interface element).

Processor 805 communicates with a storage device 830. Storage device 830 may comprise any appropriate information storage device, including combinations of magnetic storage devices (e.g., a hard disk drive), optical storage devices, and/or semiconductor memory devices.

Storage device 830 stores a program 835 and/or demand model forecaster application 840 for controlling the processor 805 for determining and/or generating demand model forecasts in accordance with the method and processes herein. Processor 805 performs instructions of the programs 835 and 840 and thereby operates in accordance with any of the embodiments described herein. Programs 835 and 840 may be stored in a compressed, uncompiled and/or encrypted format. Programs 835 and 840 may furthermore include other program elements, such as an operating system, a database management system, and/or device drivers used by the processor 805 to interface with peripheral devices.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A computer-implemented method, the method comprising:
receiving a demand model to forecast a demand for a product or service;
decomposing, by a processor, the demand model into a plurality of distinct demand components, each of the demand components associated with a causal contribution to a demand for the product or service;
generating, by the processor, a demand forecast including a plurality of demand components associated with the causal contributions contributing to the demand forecast for the product or service; and
providing a output of the generated demand forecast including the plurality of demand components.

2. The method of claim 1, wherein the plurality of demand components are either additive contributions to the forecast demand or multiplicative contributions to the demand forecast.

3. The method of claim 2, wherein the plurality of demand components are one of: all additive contributions to the demand forecast, all multiplicative contributions to the demand forecast, and a combination of additive contributions and multiplicative contributions to the demand forecast.

4. The method of claim 1, wherein the received demand model is linear comprising a base demand component and separable additive parameters, and the plurality of demand components are multiplicative contributions to the demand forecast derived from the linear demand model.

5. The method of claim 1, wherein the received demand model is non-linear.

6. The method of claim 5, wherein the non-linear demand model is multiplicative comprising a base demand component and separable multiplicative demand parameters, and the plurality of demand components are additive contributions to the demand forecast derived from the multiplicative demand model.

7. The method of claim 6, wherein the additive contributions are derived in a specific sequence from the multiplicative demand parameters of the demand model.

8. The method of claim 6, wherein the additive contributions are concurrently derived from the multiplicative demand parameters of the demand model.

9. The method of claim 6, wherein at least one of the additive contributions is derived in a specific sequence from the multiplicative demand parameters of the demand model and at least one of the additive contributions is concurrently derived from the multiplicative demand parameters of the demand model.

10. The method of claim 6, further comprising:
determining whether to derive the additive contributions from the multiplicative demand parameters of the demand model concurrently, in a specific sequence, or a combination of concurrently and specific sequence.

11. A computer-implemented method, the method comprising:
receiving historical sales data associated with a product or service;
receiving a demand model for the product or service, the demand model providing a modeled demand for the product or service;
mapping, by a processor, a plurality of distinct demand components of the demand model to the historical data, each of the demand components associated with a causal contribution to a demand for the product or service;
adjusting, by the processor, at least one of the mapped plurality of demand components to account for a difference between an actual demand for the product or service based on the historical sales data and the modeled demand; and
providing an output of the adjusted demand model.

12. The method of claim 11, further comprising decomposing, by the processor, the demand model into the plurality of distinct demand components.

13. The method of claim 11, wherein at least one of the mapped plurality of demand components is adjusted to account for a difference between the actual demand for the product or service based on the historical sales data and the modeled demand and remaining others of the plurality of demand components are not adjusted.

14. The method of claim 11, wherein the plurality of demand components includes a base demand component that is not adjusted.

15. A system, comprising:
a memory having program instructions stored thereon; and
a processor in communication with the memory, the processor being operative to:
receive a demand model to forecast a demand for a product or service;
decompose the demand model into a plurality of distinct demand components, each of the demand components associated with a causal contribution to a demand for the product or service; and
generate a demand forecast including an indication of the plurality of demand components associated with the causal contributions contributing to the demand forecast for the product or service.

16. The system of claim 15, wherein the plurality of demand components are either additive contributions to the forecast demand or multiplicative contributions to the demand forecast.

17. The system of claim 16 wherein the plurality of demand components are one of: all additive contributions to the demand forecast, all multiplicative contributions to the demand forecast, and a combination of additive contributions and multiplicative contributions to the demand forecast.

18. The system of claim 15, wherein the received demand model is linear comprising a base demand component and separable additive parameters, and the plurality of demand components are multiplicative contributions to the demand forecast derived from the linear demand model.

19. The system of claim 15, wherein the received demand model is non-linear.

20. The system of claim 19, wherein the non-linear demand model is multiplicative comprising a base demand component and separable multiplicative demand parameters, and the plurality of demand components are additive contributions to the demand forecast derived from the multiplicative demand model.

21. The system of claim 20, wherein the additive contributions are derived in a specific sequence from the multiplicative demand parameters of the demand model.

22. The system of claim 20, wherein the additive contributions are concurrently derived from the multiplicative demand parameters of the demand model.

23. The system of claim 20, wherein at least one of the additive contributions is derive in a specific sequence from the multiplicative demand parameters of the demand model and at least one of the additive contributions is concurrently derived from the multiplicative demand parameters of the demand model.

24. The system of claim 20, wherein the processor is further operative to:
determine whether to derive the additive contributions from the multiplicative demand parameters of the demand model concurrently, in a specific sequence, or a combination of concurrently and specific sequence.
